(19) United States
(12) Patent Application Publication
(10) Pub. No.: US 2022/0057178 A1
(43) Pub. Date: Feb. 24, 2022

(54) METHOD FOR ORGANIZING A HIGH-CURRENT HORIZONTALLY DIRECTED CONDUCTIVE CHANNEL IN AIR AND A DEVICE FOR IMPLEMENTATION OF THE METHOD

(71) Applicants: Yuriy Aleksandrovich GABLIYA, Moscow (RU); Yuriy Olegovich LADYAGIN, Moscow (RU)

(72) Inventor: Yuriy Alekssandrovich GABLIYA, Moscow (RU)

(21) Appl. No.: 17/281,354

(22) PCT Filed: Jan. 13, 2020
(86) PCT No.: PCT/RU2020/000010

§ 371 Date: Mar. 30, 2021

(30) Foreign Application Priority Data
Dec. 10, 2018 (RU) 2018143535

(51) Int. Cl. F41H 13/00; H01F 38/14

(52) U.S. Cl. CPC F41H 13/0012; H01F 38/14

(57) ABSTRACT

Field of the Art:

The invention relates to weapons technology.

Scope is non-lethal and less lethal remote-action weapon with electric means of damaging biological and tangible targets.

The technical effect is creation of a method for organizing a directed wireless conductive channel in air and a device for implementing the method.

The method consists in supplying a damaging electric current voltage to the ionized channel or channels of the streamers of the resonant transformer, preferably with the QCW DRSSTC topology, bypassing the active and reactive resistance of the secondary winding of the resonant transformer with the channel closure to ground or the closure of two channels with the target. The device consists of one or two resonant transformers connected through gas gaps with a source of shock voltage, while the secondary windings of the transformers can have bypass diode columns and be phased, and the source of the damaging voltage is an alternating or pulse voltage generator or a capacitive energy storage.

### FIELD OF THE ART

The invention relates to non-lethal and less lethal weapons with an electric means of damaging targets (offenders) and vehicles, and specifically to a remote electroshock weapon (DESHO).

### STATE OF THE ART

A method and device are known for organizing a directional conductive channel in the air to damage biological and tangible targets by ionizing the air with a laser beam [1]. The method is based on the fact that a UV laser beam w ith a wavelength of 248 nm creates a long-distance ionized channel in the air, by ionizing oxygen molecules of the air along its path. The ionized channel transmits a high-voltage target-striking electric current, for example, from a high-voltage pulse generator.

One or two UV lasers are used to transmit a damaging electric current voltage to the target. When one laser is used as one of the conductive channels, a laser-ionized air channel is used, to which the high-voltage voltage of one pole of the high-voltage electric current generator is supplied, and the ground is used as the other conductive channel, to which the high-voltage v oltage of the other pole of the high-voltage electric current generator is supplied. A damaging v oltage of electric current is transmitted to the target, respectively, through the circuit of the ionized laser channel-target body- ground. When using two lasers as the first and second channel for transmitting the damaging voltage of the electric current to the target, two laser-ionized air channels are used, to w hich the high-voltage voltage of one and the other pole of the high-voltage generator of electric current is supplied. A damaging voltage of electric current is transmitted to the target, respectively, through a circuit of one ionized laser channel - the target body—another ionized laser channel. As soon as the human target's body closes the electrical circuit formed by two ionized laser beams, a breakdown occurs through the ionized channels from the high-voltage electric current generator to the target human body. The theoretical, but not confirmed in practice, advantage of the device is considered the possibility of transmitting the damaging effect of electric current to the target at a distance of tens and hundreds of meters. The disadvantage of the device is the low efficiency of the transmission of electricity through the laser-ionized air channel with the enormous energy consumption required for the transmission of high-voltage damaging voltage of the electric current for only a few meters, the highest cost of pulsed UV lasers of the required power, the cumbersome design of laser energy sources that do not allow the implementation of a DESHO device wearable by one person and based on the principle of air ionization by a laser beam. 22 years have passed since the patent appeared, but the device operating at a distance of even several meters has not been implemented.

A method and device are known for organizing a directional conductive channel in the air, which are described in the source [2]. One or two thermo-ionized channels created by pyrotechnic charges with ionizing additives equipped with a profiled nozzle are used to transfer a damaging electric current voltage to the target. When using one pyrotechnic charge, a thermionic air channel is used as one of the conductive channels, to which the high-voltage voltage of one pole of the high-voltage electric current generator is supplied, and the ground is used as another conductive channel, to which the high-voltage voltage of the other pole of the high-voltage electric current generator is supplied. The striking voltage of the electric current is transmitted to the target, respectively, through the circuit of the thermally ionized channel—target body—ground. When using two pyrotechnic charges as the first and second channels for transmitting the damaging voltage of the electric current to the target, two thermo-ionized air channels are used to which the high-voltage voltage of one and the other pole of the high-voltage electric current generator is supplied. The striking voltage of the electric current is transmitted to the target, respectively, through the circuit one thermo-ionized channel—the target body—another thermo-ionized channel. As soon as the human target's body closes the electric circuit formed by two thermo-ionized channels, an electrical breakdown occurs through the thermo-ionized channels from the high-voltage generator of electric current to the target human body. The advantage of the device is the technical simplicity of implementation and its low cost, including only the cost of pyrotechnic charges with ionizing additives, which have long been developed for use in MPD generators. The disadvantage is the impossibility of technically simple and low cost organization of thermo-ionized channels with a duration of more than 1 m, and the possibility of burns to the target's body or ignition of the target's clothing with hot gas streams from combustion of a pyrocharge.

### DISCLOSURE OF INVENTION

The aim of the invention is to create a method for organizing a high-current horizontally directed conductive channel in the air to strike biological and tangible targets without the disadvantages of the known methods.

The aim of the invention is also to create a device for implementing the method, which device organizes a horizontal high-current directional conductive channel in the air to destroy biological and tangible targets, devoiding of the drawbacks of known devices for striking biological and tangible targets by electric current through a pre-ionized channel.

The essence of the method according to the invention lies in the fact that a high-current damaging voltage of direct, alternating or pulsed electric current, which is supplied to at least one high-frequency low-current ionized streamer channel created by at least one resonant transformer preferably with the QCW DRSSTC topology (Quasi Continuous Wave Dual Resonant Solid State Tesla Coil), preferably bypassing the active and reactive resistance of the secondary winding of the resonant transformer, organizes a second conductive channel through the ground or a streamer of another resonant transformer, preferably with the QCW DRSSTC topology, preferably bypassing the active and reactive resistance of the secondary winding of the resonant transformer, and directs the high-current damaging electric current voltage at least through one streamer and the second conductive channel to the target.

A device for organizing a high-current horizontally directional conductive channel in the air consists of a source of electric current that damages the target, wherein one lead or pole of the source of the damaging electric current is configured to electrically connect to the end of the secondary winding of at least one resonant transformer, preferably with the QCW DRSSTC topology, ensuring the possibility of the damaging electric current entering the streamer of the resonant transformer, preferably bypassing the active and reactive resistance of the secondary winding, and the second pole or lead of the source of damaging electric current is connected to ground or is configured to electrically connect to the end of the secondary winding of another resonant transformer, preferably with the QCW DRSSTC topology, ensuring the possibility of the damaging electric current entering the streamer of the resonant transformer, preferably bypassing the active and reactive resistance of the secondary winding.

An additional feature is that one pole or lead of the source of damaging electric current is configured to electrically connect to the cold end of the secondary winding of the resonant transformer, ensuring the possibility of the damaging electric current entering the streamer of the resonant transformer through the gas gap, preferably 1.05-1.1 times the length of the breakdown through the air of the source of damaging electric current or by means of galvanic connection, and the second pole or lead of the source of damaging electric current is connected to the ground or is configured to electrically connect to the cold end of the secondary winding of another resonant transformer with the possibility of the damaging electric current entering the streamer of another resonant transformer through the gas gap, preferably 1.05-1.1 times the length of the breakdown distance through the air of the source of damaging electric current or by means of galvanic connection.

An additional feature lies in the fact that the secondary winding of the resonant transformer is shunted by a diode column, one pole or the lead of the source of the damaging electric current is configured to electrically connect to the cold end of the secondary winding of the resonant transformer, providing the possibility of the damaging electric current entering the streamer of the resonant transformer through the gas gap or using galvanic connection, and the second pole or lead of the source of the damaging electric current is connected to ground.

An additional feature lies in the fact that one pole or lead of the source of damaging electric current is connected to one end of the diode column, and the other end of the diode column is configured to electrically connect to the hot end of the secondary winding of the first resonant transformer, ensuring the possibility of the damaging electric current entering through the diode column into the resonant streamer transformer through the gas gap or using galvanic connection, and the second pole or lead of the source of damaging electric current is configured to electrically connect to the end of the second diode column, the other end of the second diode column is configured to electrically connect to the hot end of the secondary winding of the second resonant transformer, ensuring the possibility of the damaging electric current to enter through the diode column into the streamer of the second resonant transformer through the gas gap or using galvanic connection, while the cold ends of the secondary windings of both resonant transformers are connected.

An additional feature lies in the fact that the secondary windings of the two resonant transformers are shunted by diode columns, one pole or lead of the source of the damaging electric current is configured to electrically connect to the cold end of the secondary winding of the first resonant transformer, ensuring the possibility of the damaging electric current entering the streamer of the resonant transformer through the gas gap or using galvanic connection, and the second pole or lead of the source of the damaging electric current has the possibility of electrical communication with the cold end of the secondary winding of the second resonant transformer, ensuring the possibility of the damaging electric current entering the streamer of the resonant transformer through the gas gap or using galvanic connection.

An additional feature is that the source of damaging electric current is the transformer powered by an alternating or impulse voltage source, or is an electric capacity charged from a direct current source.

An additional feature lies in the fact that the source of the damaging electric current is the first electrical capacitance connected by the switch to the larger value second capacitance charged from a constant voltage source.

An additional feature is that the secondary windings of the resonant transformers are phased.

### Note

In the description of the application, the English-language terminology of resonant transformer topologies is used due to the fact that there are no domestic scientifically established and technically unambiguous Russian-language terms denoting these topologies.

### BRIEF DESCRIPTION OF DRAWINGS

FIG. 1. Diagram of the weapon according to claim 3 of the Claims with the second conductive line to ground (the resonant transformer is indicated as primary and secondary windings only).

FIG. 2. Diagram of the weapon according to claim 3 of the Claims with the second conductive streamer line of the second resonant transformer (transformers are indicated as primary and secondary windings only).

FIG. 3. Diagram of the weapon according to claim 4 of the Claims with the second conductive line and one bypass diode column (the resonant transformer is designated as primary and secondary windings only).

FIG. 4. Diagram of the weapon according to claim 5 of the Claims with the second conducting streamer line of the second resonant transformer and two bypass diode columns (the transformers are indicated as primary and secondary windings only).

FIG. 5. Diagram of an embodiment of the weapon according to claim 6 of the Claims with the second conductive streamer line of the second resonant transformer and two bypass diode columns (transformers are indicated as primary and secondary windings only).

FIGS. 6a; 6b; and 6c. Embodiments of the design of the source of damaging electric current 5.

### IMPLEMENTATION OF THE INVENTION

The method is based on the fact that a high-current damaging voltage of an electric current is applied to a high-frequency low-current ionized channel of a streamer created by at least one resonant transformer of preferably QCW DRSSTC topology (Quasi Continuous Wave Dual Resonant Solid State Tesla Coil), wherein the second conductive channel to the target is organizing through the ground, or, which is most expedient, through the streamer of the second resonant transformer with said topology, connected to the first transformer, preferably bypassing the active and reactive resistance of the secondary winding of the transformers and directing one streamer to the target in the case of using the second conductive channel to the ground target or two streamers in the case of using the streamer of the second resonant transformer as the second conductive channel to the target. Bypassing the high-current damaging voltage of the secondary windings of resonant transformers is achieved by using high-voltage diode poles that do not allow the passage of a high-current damaging electric current voltage into the secondary windings of resonant transformers that have a large active and reactive parasitic resistance but enable it to pass through ionized channels with negligible resistance, to the target.

The target is damaged by transmitting a high-current damaging voltage to the target through two channels which, in the first case, are the streamer of one resonant transformer and ground, and in the second case, the streamer of one resonant transformer and the streamer of the second resonant transformer, which is connected to the first one. In the second case described, the distance between two streamers aimed at the target close to the parallel position of the streamers relative to each other, wherein the distance between the streamers should be greater than the possible electrical breakdown distance of the damaging current voltage between adjacent streamers or streamers and the ground.

The main difference between the proposed method and the existing ones is that the supply of the high-current damaging voltage of electric current is produced not into a channel formed by a simple physical breakdown of gas (air), but into a high-frequency streamer ionizing air that is continuously growing and fed by the pumping energy of the primary winding of the resonant transformer. Therefore, for the organization of the same breakdown distance with a damaging electric current voltage according to the proposed method, a much more technologically advanced and cheap resonant transformer with a single-layer winding of the secondary winding is applicable, which does not need special types of high-voltage insulation and the organization of insulation of the spaces surrounding the device than high-voltage pulse transformers of multi-layer or sectional winding or high-voltage generators of other type (for example, the Marx generator) for a simple physical breakdown in gas. The use of the topology of resonant transformers QCW DRSSTC with the supply of the high-current damaging voltage of electric current to the channel of the super-extended streamer makes it possible to create high-current directional conductive channels in the air for wireless non-lethal weapons with electric means of damaging biological and tangible targets in devices worn by one person or carried on automobiles. When attempting to use for the same purposes, the well-known but not resonant high-voltage technology of the megavolt class, the dimensions and weight of such devices make it impossible to create a wireless weapon with an electric weapon not only worn by one person, but even rapidly deployed by a truck.

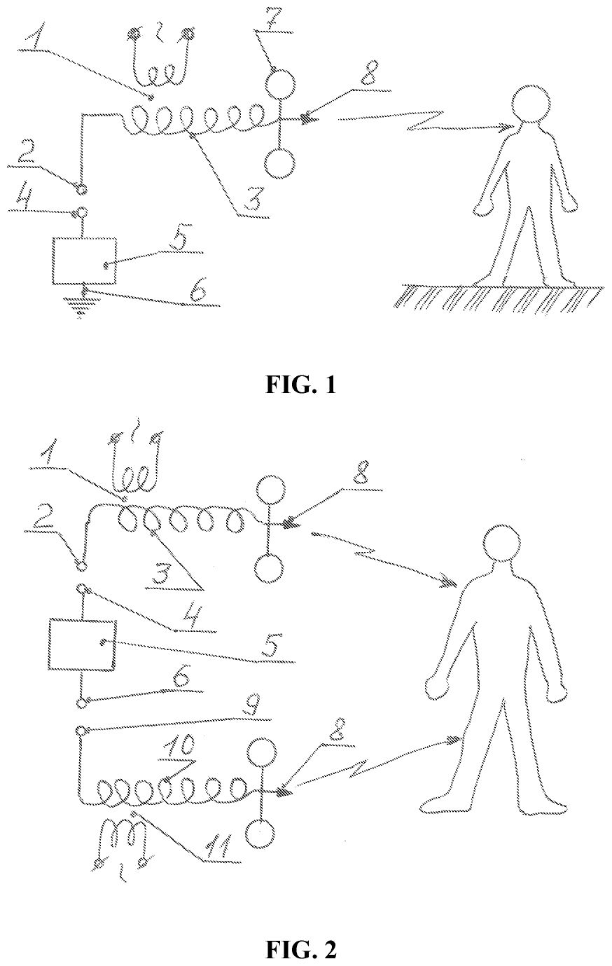

FIG. 1. A device for implementing the method consisting of a resonant transformer 1 with preferably QCW DRSSTC topology near the cold end 2 (i.e., the lead of the secondary winding closest to the primary winding) of the secondary winding 3, preferably with an air gap, preferably 1.05-1.1 times the length of the distance breakdown through the air of the source of damaging electric current, one pole or lead 4 of the source of damaging electric current 5 is located, and the second pole or lead 6 of the source of damaging electric current 5 is connected to ground. A toroidal or having the form of another body of rotation lead (output lead, torus, toroid or top load capasitor) (output) 7 serving as an additional electrical capacity of the secondary winding, responsible for resonance and reducing the leakage of the induced potential into the atmosphere, has a tip directed along the axis of the secondary winding called in the field of the development of resonant transformers in the West “spark point” 8 and serving to concentrate streamers in the desired direction. In some cases, the resonant transformer may not have a lead in the form of a torus or other body of revolution, and in this case, the lead is simply the lead of the hot end of the secondary winding, a pointed “spark point”.

When the resonant transformer is switched on, the high-frequency potential induced in the secondary winding forms the main streamer growing from the “spark point” 8 to a grounded object (in this case, a conductive target on the ground), and a breakdown streamer in the air gap between cold end 2 and lead 4. Upon reaching the main streamer of the target into the ionized channel of the main streamer and the streamer formed in the air gap between the cold end 2 and the lead 4 connecting the secondary winding to the ground during the electric breakdown of the main streamer to the target through the source of damaging electric current 5 and having a low resistance, a high-current damaging electric current voltage begins to pass from the source of damaging electric current 5.

The electric shock to the target thus occurs, respectively, along the path of the damaging electric current voltage from the “spark point” 8 through the conductive target to the ground. The presence of the air gap between the cold end 2 and lead 4 does not allow the potential of the source of damaging electric current to drain into the air through the large area of lead 7 and the sharpened “spark point” at the moment of the formation of a high-frequency ionized channel that is configured to dissipate potentials, and at the same time allows for unhindered passage a large current of the source of damaging electric current to the target after the final formation of the ionized channel and the breakdown of the spark to the target. In another embodiment of the device, instead of the air gap, a gas spark gap can be used with a trigger voltage higher than the open circuit voltage of the source of damaging electric current. In addition, the presence of the air gap eliminates the possibility of injury to the user from the source of damaging voltage of electric current by accidentally touching the “spark point” 8 or the lead in the case of operation of the source of damaging voltage of electric current, without switching the resonant transformer on. To simplify the device, to the detriment of the characteristics of the leakage potential of the damaging electric current and the safety of use thereof, a direct galvanic connection can also be arranged between the cold end 2 and the lead 4. The described embodiment of the device has the significant disadvantage that the ground has a significant intrinsic resistance, which reduces the value of the damaging electric current and, accordingly, the effectiveness of the impact on the target. What has been said about the preferred need for the air (gas) gap also applies to all embodiments of the device described in FIG. 2; 3; 4; 5.

FIG. 2. A device for implementing the method consisting of a resonant transformer 1 with a preferably QCW DRSSTC topology near the cold end 2 of the secondary winding 3, preferably with an air gap, preferably 1.05-1.1 times the length of the breakdown distance through the air of the source of damaging electric current, one pole or lead 4 of the source of damaging electric current 5, and near the second pole or lead 6 of the source of damaging electric current 5, preferably with the air gap of preferably 1.0-1.1 length of the breakdown distance through the air of the source of damaging electric current, the cold end 9 of the secondary winding 10 of another resonant transformer 11 of the same type is located. By simultaneously switching on both resonant transformers on, high-frequency potentials induced in the secondary windings of the transformers form the main streamers growing from the “spark point” to the conductive object (in this case, the conductive target). When the main streamers reach the secondary windings of the target, the damaging electric current voltage from the source of damaging electric current 5 begins to pass into the ionized channels of the main streamers with low resistance and the channels of the electric breakdown streamers of the air gaps (pos. 2-pos. 4) and (pos. 6-pos. 9) connecting the secondary windings during the breakdown of the main streamers to the target.

The target is damaged by an electric discharge, respectively, along the path of the voltage of the damaging electric current from the “spark point” 8 of the transformer 1 through the conductive target to the “spark point” 8 of the transformer 11.

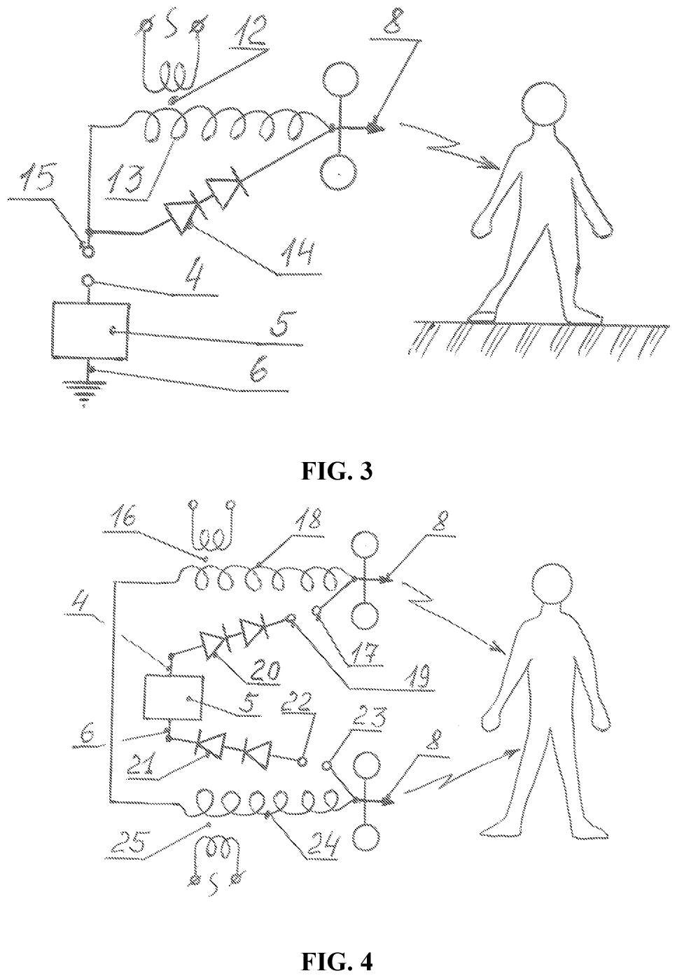

FIG. 3. A device for implementing the method consisting of a resonant transformer 12 with preferably QCW DRSSTC topology, the secondary winding 13, which is shunted by a high-voltage diode column 14. Near the connection 15 of the cold end of the secondary winding with the lead of the shunting diode column 14, preferably with an air gap of preferably 1.05-1.1 times the length of the breakdown distance through the air of the source of damaging electric current, one pole or lead 4 of the source of damaging electric current 5 is located, and the second pole or lead 6 of the source of damaging electric current 5 is connected to the ground.

When the resonant transformer is shunted on, the high-frequency potential induced in the secondary winding 13 forms the main streamer growing from the “spark point” 8 to a grounded object (in this case, a conductive target).

When the main streamer reaches the target, the damaging voltage of electric current from the source of damaging electric current 5 begins to pass into the ionized channel of the main streamer and the channel of the electric breakdown streamer of the air gap (pos. 4-pos. 15) connecting the secondary winding to the ground and having a low resistance during the breakdown of the main streamer to the target.

A diode column 14 prevents the winding 13 from short-circuiting and does not interfere with the passage of the damaging electric current voltage to the target.

Due to the low forward resistance of the diode column 14 in comparison with the active and reactive resistance of the secondary winding 13, the power losses of the voltage of the damaging electric current damaging the target in such a transformer switching circuit are minimal, and the visual effect of the damaging spark discharge is maximum, which is necessary for very effective psychological impact on offenders. The damaging the target by an electric discharge occurs, respectively, along the path of the voltage of the damaging electric current from the “spark point” 8 of the transformer 12 through the conductive target to the ground.

FIG. 4. A device for implementing the method consisting of a resonant transformer 16 with preferably QCW DRSSTC topology near the hot end 17 (i.e., the lead of the secondary winding farthest from the primary winding) of the secondary winding 18, preferably with an air gap of preferably 1.05-1.1 times the length the distance of breakdown through the air of the source of damaging electric current, lead 19 of a high-voltage diode column 20 is located; the second pole or the lead of which is connected to one pole or lead 4 of the source of damaging electric current 5, the second pole or lead 6 of the source of damaging electric current 5 is connected to one pole or lead of the second high-voltage diode column 21 the second pole or lead 22 of which, preferably with an air gap of preferably 1.0-1.1 times the lengths of the breakdown distance through the air of the source of damaging electric current, is located near the hot end 23 of the secondary winding 24 of the second resonant transformer 25 of the same type. In this case, the cold ends of the secondary windings of both resonant transformers are electrically connected.

When the resonant transformers are switched on, the high-frequency potentials induced in the secondary windings 18 and 24 form the main streamers growing from their “spark point” to the conductive object (in this case, the conductive target). When the main streamers reach the target, the damaging voltage of electric current from the source of damaging electric current 5 begins to pass into the ionized channels of the main streamers and channels of streamers of electric breakdown of air gaps (pos. 17-pos. 19) and (pos. 22-23) connecting the source of damaging electric current 5 to the target during the electric breakdown of the main streamers to the target with the target and having a low resistance. Due to the low forward resistance of the diode columns 20 and 21 in comparison with the active and reactive resistance of the secondary windings 18 and 24, the power losses of the damaging electric current affecting the target in such a transformer switching circuit on are minimal, and the visual effect of the damaging spark discharge is maximum. The damaging the target with an electric discharge thus occurs, respectively, along the path of the voltage of the damaging electric current from the “spark point” 8 of the transformer 16 through the conductive target to the “spark point” 8 of the transformer 25.

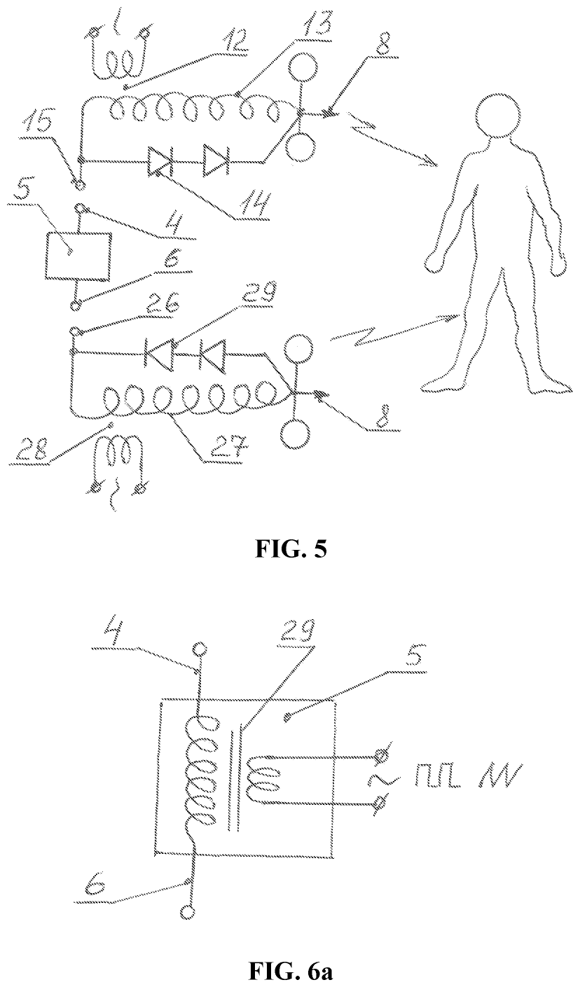

FIG. 5. An embodiment of the device for implementing the method consists of a resonant transformer 12 with a preferably QCW DRSSTC topology, the secondary winding 13 of which is shunted by a high-voltage diode column 14. Near the connection 15 of the cold end of the secondary winding with the lead of the shunting diode column 14, preferably with an air gap of preferably 1.05-1.1 times the length of the breakdown distance through the air of the source of damaging electric current, one pole or lead 4 of the source of the damaging electric current 5 is located, and the second pole or lead 6 of the source of the damaging electric current 5 preferably with an air gap, preferably 1.0-1.1 times the length of the distance of the breakdown through the air of the source of damaging electric current is located near the place 26 of the connection of the cold end of the secondary winding 27 of the second resonant transformer 28 of the same type with one of the poles or leads of the second shunting of the secondary winding of the second high-voltage diode column 29, while the second pole or the lead of the high-voltage diode column 29 is connected to the hot end of the secondary winding 27 of the transformer 28.

When both resonant transformers are switched on, the high-frequency potentials induced in the secondary windings 13 and 27 form the main streamers growing from the spark point towards a conductive object (in this case, a conductive target).

When the main streamers reach the target, the damaging voltage of the electric current from the source of the damaging electric current 5 begins to pass into the ionized channels of the main streamers and the channels of the electric breakdown streamers, air gaps (pos. 4-pos. 15) and (pos. 6-26) connecting the source of damaging electric current 5 to the target during the breakdown of the main streamers to the target and having a low resistance. Due to the low forward resistance of the diode columns 14 and 29 in comparison with the active and reactive resistance of the secondary windings 13 and 27, the power losses of the damaging electric current affecting the target in such a circuit for switching transformers on are minimal, and the visual effect of the damaging spark discharge is maximal. The target is struck by an electric discharge in this way, respectively, along the path of the voltage of the destructive electric current from the “spark point” 8 of the transformer 12 through the conductive target to the “spark point” 8 of the transformer 28.

In embodiments of the device of FIG. 2, 4, 5, resonant transformers of the same type can be specially phased along their primary or secondary windings to obtain the addition of the potentials of the secondary windings.

The operation of the considered devices is possible not only in the mode of resonant pumping of the secondary winding of transformers, but also in the mode of pulsed pumping of the primary winding by periodic current pulses, as well as in the mode of using pulse-periodic generators (SINUS; RADAN) with a Tesla transformer [5; 6]. In such an embodiment of the proposed invention, it is advisable to use high-voltage transformers not in air, but with oil interwinding insulation. However, in this case, the length of the main streamer for ionization of the damaging current channel is significantly reduced.

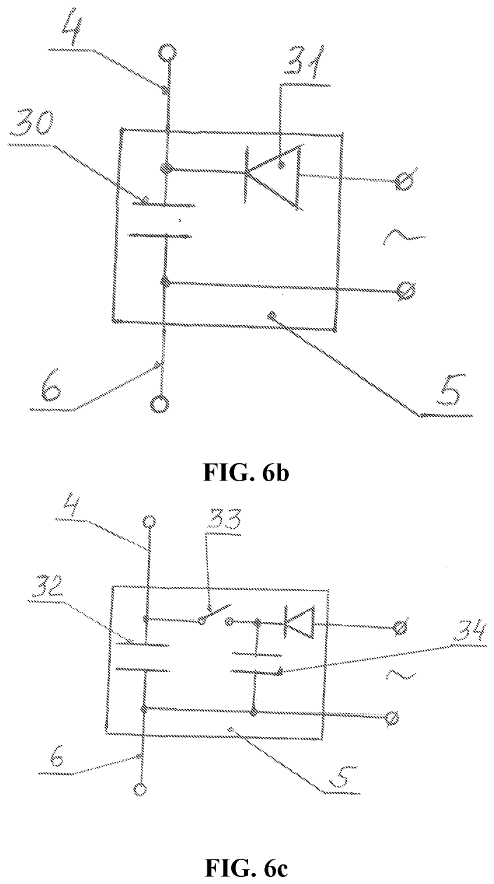

FIG. 6 a. The source of damaging electric current 5 consists of a transformer 29, the outputs of the secondary winding of which are leads 4 and 6, a source of damaging electric current 5, the primary winding of which is powered by alternating or pulsed voltage from a separate generator. This circuit can work with all kinds of resonant transformer topologies.

FIG. 6 b. The source of damaging electric current 5 according to FIG. b consists of a capacitor 30 charged with constant voltage via a diode column or diode bridge 31 from a separate alternator. This circuit works with QCW DRSSTC resonant transformer topology or VTTC topology with chopper. When the transformer (or two transformers) outputs the main streamers, the charged capacitor 30 is discharged through its streamer and ground or through two streamers to the target. Before repetition of the next burst of pulses of the resonant transformer, the capacitor 30 is charged again.

FIG. 6 c. The source of damaging electric current 5 according to FIG. c consists of a small capacitor pass-through 32 of small capacity connected through a switch 33 (for example, static or controlled gas discharge tube or solid-state switch) with a continuously charged direct current generator with an additional capacitor 34 of large capacity. This circuit can work with resonant transformers of all topologies.

When the resonant transformer (or two transformers) issues the main streamers, the capacitor 34 is connected to the capacitor pass-through 32 in parallel by closing the switch 33 and discharged through the resonant transformer streamer and the second conducting channel to the target with a high-current damaging pulse. Then the switch is opened to charge the capacitor 34. When the switch 33 is open, only low-current high-frequency streamers of constantly operating resonant transformers can pass to the target, which do not have a significant physiological or damaging effect on tangible targets, for example, with a preventive purpose (warning against active actions) against the offender. Then the switch is closed and a high-current destructive impulse passes to the target again, etc. sequentially according to the described algorithm until the target is struck.

The charging voltage of the capacitor 30 and the additional capacitor 34 can be 2-20 kV or more, and the capacitance value of these capacitors can range from units of microfarads to thousands of microfarads, depending on the desired degree of physiological effect on biological targets or the degree of desired damage or disabling of tangible targets, such as automobiles. Capacitors 30 and 34 can be composed of a bank of capacitors, and in this case, by choosing the number of chargeable capacitors in the bank, one or another given effect on the target can be adjusted. The effectiveness of the impact on the target can also be adjusted by changing the charging voltage of the capacitors or by changing the voltage supplied to the transformer 29.

When using the proposed devices against biological targets, the accuracy of striking a streamer with a damaging current into less traumatic areas of the body (i.e., the impossibility of striking the head, eyes, etc.) is of particular importance, but in addition, the possibility of precise adjustment of the extent of physiological effects.

In the described device, it is possible to use resonant transformers with SGTC topologies (Spark Gap Tesla Coil); SSTC (Solid State Tesla Coil); VTTC (Vaccuum Tube Tesla Coil); DRSSTC (Dual Resonant Solid State Tesla Coil), however, only resonant transformer with the QCW DRSSTC topology makes it possible to obtain streamer directed, as a rule, and preferably along the magnetic field lines from the end of the secondary winding or lead in the form of toroid or other body of revolution with “spark point” located along the axis of the coil of the resonant transformer forward along the axis of the coil and is practically rectilinear (which is achieved by an appropriate setting of the resonant frequency, the pumping rate of the primary winding, and the magnitude of the voltage of the electric current (or rather the power of the electric current) supplied to the primary winding. The streamer that has arisen at a low voltage on the secondary winding continues to be energized during the entire pumping time, and therefore grows upward along the lines of the field, instead of breaking through the side of the toroid on the “strike ring” (“strike ring”, “shock” or “protective” ring from breakdowns from the secondary winding to the primary) or the ground. It is for this that smooth pumping in the resonant transformer with QCW DRSSTC topology is set. Due to smooth pumping, the following effect is achieved: first, a small discharge appears (streamer seed), which then grows not at a high speed, piercing the ionized channel of the streamer, but at a low one (so that this development process is recorded even by ordinary, not high-speed video cameras), which determines the non-branching of the streamer and the huge length relative to the length of the secondary winding. The resonant transformer with the QCW DRSSTC topology works, as it were, heating up more and more during the pumping of the primary circuit a small initially formed streamer, which lengthens as energy is pumped into the secondary winding. The voltage at the lead of the secondary winding of the resonant transformer with the QCW DRSSTC topology is small and does not exceed tens of kilovolts. A resonant transformer with a QCW DRSSTC topology is a transformer with a high coupling coefficient (0.6-1.0) in which the primary winding is close to the secondary (and can be supplied with a core of various brands of high-frequency ferrites) but at low voltage potentials of the electric current on the secondary winding of electrical breakdowns between the primary and secondary windings does not occur, and therefore this topology, unlike other topologies of resonant transformers, does not need striking.

When the resonant transformer with the QCW DRSSTC topology is located horizontally (the winding axis is oriented horizontally), the streamers formed during its operation are also directed horizontally (xiphoidal pairs without branching), i.e. parallel to the ground and at optimal setting (see above) do not form sparks to the ground, which, when using two resonant transformers with a QCW DRSSTC topology, makes it possible to obtain two streamers oriented horizontally to the ground and practically parallel along which a high-current damaging voltage of electric current can be applied to a target with a vertical position (for example, a human or a vehicle). No other topology of resonant transformers makes it possible to obtain streamers parallel to each other and to the ground without branching. DESHO topologies other than QCW DRSSTC do not make it possible to receive long electrically conductive ionized channels parallel to the ground and to each other.

The choice of resonant transformer topologies for a specific application is based on the intended type of target. For example, to damaging vehicles, it is possible to use the VTTC topology as the simplest and cheapest in technical terms and giving streamers of considerable length, but insignificant “accuracy” of hitting the target. In this case, the height of the “spark point” should be significantly greater than the length of the ground fault, since the streamers of the resonant transformer of the VTTC topology tend to go in the ground direction to a much greater extent than the QCW DRSSTC topologies.

Thus, streamers of resonant transformers of VTTC topology can be used only for damaging targets with large vertical dimensions, for example, targets in the form of vehicles, and the length of the streamers of resonant transformers of VTTC topology practically never exceed 2-2.5 lengths of the secondary winding.

At the present stage of the development of the QCW DRSSTC topology, the resulting xiphoidal streamer without branches can reach a length exceeding the length of the secondary winding by 12-15 times. In practice, this means that a resonant transformer with a QCW DRSSTC topology and with a secondary winding length of, for example, one meter (the size of the entire installation can be easily transported by light transport) can provide a directional and practically rectilinear electrically conductive horizontal channel up to 15 m long. At the same time, trends of development of the techniques for the development and construction of resonant transformers of various topologies and the emergence of new topologies in the West make it possible to expect the obtaining of streamers of even greater length and, accordingly, an even greater distance of striking targets by the described method. At the same time, due to the high frequency of pumping pulses of the secondary winding in practical designs of resonant transformers with QCW DRSSTC topology (resonant frequency 380-420 kHz), i.e. with their negligible duration, the physiological effectiveness of the impact of the spark developed from the streamer, even if it passes from the hot end of the secondary winding through the biological target to the ground, is negligible. Due to the low voltage value in the secondary winding of the resonant transformers of the QCW DRSSTC topology and, accordingly, the small own spark current, the effectiveness of the impact on the target can only be regulated by the power of the damaging electric current generator 5 delivered to the target-striking circuit.

In a resonant transformer of the QCW DRSSTC topology, the total voltage at the lead does not exceed tens of kilovolts, in contrast, for example, to the SGTC topology transformer (hundreds of kilovolts or more), therefore, in the devices according to FIG. 3, 4, 5 it is possible to use serially produced bypass high-voltage diode columns (for example, SDL-0.4-1600, or SDLM-0.4-1600, or recruited, for example, from diode poles of type 2Ts202E), the purpose of which is to prevent shunting of the secondary winding by high high-frequency voltage and passing a high-current damaging electric current voltage from the source of damaging electric current 5 bypassing the secondary winding. Diode columns (assemblies) for operation in the circuits of FIG. 3, 4, 5 should be configured to withstand a reverse voltage of no more than tens to hundreds of kilovolts with an allowable forward impulse current of units and tens of amperes to damage biological targets and hundreds and thousands of amperes to damage tangible objects.

### LIST OF CITED SOURCES

1. U.S. Pat. No. 5,675,103/
2. Ladyagin YuO “Remote electroshock weapon” Moscow: Stalingrad Foundation Publishing House, 2017, pp. 278-283.
3. https://en.wikipedia.org/wiki/Tesla_coil
4. Loughborough University Institutional Repository “A compact and portable EMP generator based on Tesla transformer technology” p. 54.
5. Belkin N V, Khudyakova L N, Bogolyubov V V, Tarakanov MYu “High-voltage block of short pulse generator with three-electrode tube”. PTE No. 1, 1981, p. 224-225).
6. Shpak V G, Shunailov S A, Yalandin M I, Dyadkov A N “Small-sized high-current pulse source RADAN SEF-303A”. PTE No. 1, 1993, pp. 149-155.

1. A method of organizing a high-current horizontally directed conductive channel in the air based on the fact that a high-current damaging voltage of direct, alternating or pulsed electric current is supplied to at least one high-frequency low-current ionized streamer channel created by at least one resonant transformer, preferably with the QCW DRSSTC topology (Quasi Continuous Wave Dual Resonant Solid State Tesla Coil), preferably bypassing the active and reactive resistance of the secondary winding of the resonant transformer, organize a second conductive channel through the ground or a streamer of another resonant transformer with preferably QCW DRSSTC topology, preferably bypassing the active and reactive resistance of the secondary winding of the resonant transformer and directing a high-current damaging electric current through at least one streamer and a second conductive channel to the target.

2. A device for organizing a high-current horizontally directional conductive channel in the air containing a source of electric current that damages the target, wherein one lead or pole of the source of damaging electric current is configured to electrically connect to the end of the secondary winding of at least one resonant transformer preferably with the QCW DRSSTC topology, providing the possibility of the damaging electric current entering the streamer of a resonant transformer preferably bypassing the active and reactive resistance of the secondary winding, and the second pole or lead of the source of the damaging electric current is connected to the ground or is configured to electrically connect to the end of the secondary winding of another resonant transformer preferably with the QCW DRSSTC topology, ensuring the possibility of supply damaging electric current into the streamer of the resonant transformer, preferably bypassing the active and reactive resistance of the secondary winding.

3. The device according to claim 2, wherein one pole or lead of the source of damaging electric current is configured to electrically connect to the cold end of the secondary winding of the resonant transformer, providing the possibility of entering the damaging electric current into the streamer of the resonant transformer through the gas gap of preferably 1.05-1.1 times the length of the breakdown distance through the air of the source of damaging electric current or by means of galvanic connection, and the second pole or lead of the source of damaging electric current is connected to the ground or is configured to electrically connect to the cold end of the secondary winding of another resonant transformer, providing the possibility of the damaging electric current entering the streamer of another resonant transformer through the gas gap, preferably 1.05-1.1 times the length of the breakdown distance through the air of the source of damaging electric current or by means of galvanic connection,

4. The device according to claim 2, wherein the secondary winding of the resonant transformer is shunted by a diode column, one pole or lead of the source of damaging electric current is configured to electrically connect to the cold end of the secondary winding of the resonant transformer, providing the possibility of entering the damaging electric current into the streamer of the resonant transformer through the gas gap or by means of galvanic connection, and the second pole or lead of the source of the damaging electric current is connected to ground.

5. The device according to claim 2, wherein one pole or lead of the source of damaging electric current is connected to one end of the diode column, and the other end of the diode column is configured to electrically connect to the hot end of the secondary winding of the first resonant transformer, providing the possibility of the damaging electric current through the diode column into the streamer of the resonant transformer through the gas gap or using galvanic connection, and the second pole or lead of the source of damaging electric current is configured to electrically connect to the end of the second diode column, the other end of the second diode column is configured to electrically connect to the hot end of the secondary winding of the second resonant transformer providing the possibility of the damaging electric current entering through the diode column into the streamer of the second resonant transformer through the gas gap or using galvanic connection, while the cold ends of the secondary windings of both resonant transformers are connected.

6. The device according to claim 2, wherein the secondary windings of the two resonant transformers are shunted by diode columns, one column or lead of the source of damaging electric current is configured to electrically connect to the cold end of the secondary winding of the first resonant transformer, providing the possibility of the damaging electric current entering the streamer of the resonant transformer through the gas gap or by means of galvanic connection, and the second pole or lead of the source of the damaging electric current is configured to electrically connect to the cold end of the secondary winding of the second resonant transformer, ensuring the possibility of the damaging electric current entering the streamer of the resonant transformer through the gas gap or by means of galvanic connection.

7. The device according to claim 2, wherein the source of damaging electric current is a transformer powered by an alternating or impulse voltage source or is an electrical capacitance charged from a direct current source.

8. The device according to claim 7, wherein the source of damaging electric current is the first electrical capacitance connected by a switch with a second capacitance of a larger value charged from a constant voltage source.

9. The device according to claim 3, wherein the secondary windings are phased.
